(19) United States
(12) Patent Application Publication
(10) Pub. No.: US 2026/0187322 A1
(43) Pub. Date: Jul. 2, 2026

(54) PHYSICS-BASED PETROPHYSICAL MODELS USING SYNTHETIC DATA AND SYMBOLIC REGRESSION

(71) Applicant: Halliburton Energy Services, Inc., Houston, TX (US)

(72) Inventors: Mayir Mamtimin, Houston, TX (US); Songhua Chen, Houston, TX (US); Zulkuf Azizoglu, Houston, TX (US)

(73) Assignee: Halliburton Energy Services, Inc., Houston, TX (US)

(21) Appl. No.: 19/092,602

(22) Filed: Mar. 27, 2025

Related U.S. Application Data
(60) Provisional application No. 63/741,324, filed on Jan. 2, 2025.

(51) Int. Cl. G06F 30/28; G06F 111/10; G06F 113/08

(52) U.S. Cl. CPC G06F 30/28; G06F 2111/10; G06F 2113/08

(57) ABSTRACT

A method for creating a physics based analytical model. The method may include, identifying a fundamental physics law and interaction for modeling, creating a forward modeling computational tool from the fundamental physics law and interaction, and inputting synthetic data into the forward modeling computational tool. The method may further include creating a symbolic regression from forward modeling computational tool using the synthetic data, creating a model or formula based at least in part on the symbolic regression, and calibrating the model or formula to form a physics based analytical model.

### BACKGROUND

In the realm of scientific and engineering challenges, developing physics-based analytical models for intricate and multifaceted problems presents a formidable task. The complexity of these problems often stems from the interplay of numerous variables and the subtleties of their interactions, which can be difficult to capture with traditional modeling techniques. As a result, researchers and practitioners frequently resort to machine learning (ML) and deep learning neural networks to decipher the underlying correlations and mechanisms. While these methods are powerful in identifying patterns within large datasets, they typically operate as “black-box” models that offer little to no insight into the physics driving the phenomena. This lack of interpretability is a significant drawback, as it obscures the causal relationships and fundamental principles that are crucial for understanding, predicting, and controlling the systems under study. The proposed idea seeks to address these challenges by leveraging symbolic regression on synthetic data, aiming to uncover interpretable models that faithfully represent the underlying physics, thus bridging the gap between data-driven insights and physical theory.

### BRIEF DESCRIPTION OF THE DRAWINGS

These drawings illustrate certain aspects of some of the embodiments of the present disclosure and should not be used to limit or define the disclosure.

FIG. 1 illustrates an example of a measurement while drilling operation;

FIG. 2 illustrates an example of a logging tool measurement operation;

FIG. 3 illustrates a schematic of an information handling system;

FIG. 4 illustrates a schematic of a chip set;

FIG. 5 illustrates a computing network;

FIG. 6 illustrates a neural network;

FIG. 7 is a workflow for forming a physics-based petrophysical model; and

FIG. 8 is a graph illustrating FIG. 8 illustrates the performance n estimating oil holdup Y₀.

FIG. 9 is a graph the laboratory data/real world data against the synthetic data.

FIG. 10 is a graph illustrating the performance of estimating oil holdup Y₀.

FIG. 11 is a graph illustrating the performance in oil holdup Y₀ estimation for all possible combinations of cross-validation.

### DETAILED DESCRIPTION

Disclosed herein are methods and systems for constructing interpretable physics-based analytical models for complex systems. As discussed further, methods and systems may integrate fundamental physical laws into a computational framework for forward modeling. This framework may be employed to generate comprehensive synthetic datasets that capture the entire spectrum of the physical phenomena and the variability of all relevant parameters. Symbolic regression may then be applied to these synthetic datasets to distill a model or formula that not only embodies the underlying physical principles but is also inherently interpretable. The resulting expressions, which are semi-analytical in nature, comprise adjustable constants and coefficients that may be calibrated with real-world or laboratory data. This methodology ultimately produces an explainable, physics-grounded analytical model that circumvents the difficulties typically encountered in modeling complex systems directly.

Methods and systems described herein comprise fusion of synthetic data generation with symbolic regression to create physics-based models that are both interpretable and grounded in the underlying science, a stark contrast to the opacity of black-box machine learning methods. By systematically exploring the parameter space and capturing the full complexity of the physical interactions through synthetic datasets, this method circumvents the limitations of empirical data scarcity and noise. Symbolic regression then serves as a powerful tool to reveal the intrinsic mathematical relationships, yielding semi-analytical formulas that not only elucidate the governing physics but also allow for straightforward calibration against real-world observations. This strategy stands out by providing a clear window into the mechanics of complex systems, enabling a deeper understanding and more accurate predictions than traditional data-driven approaches.

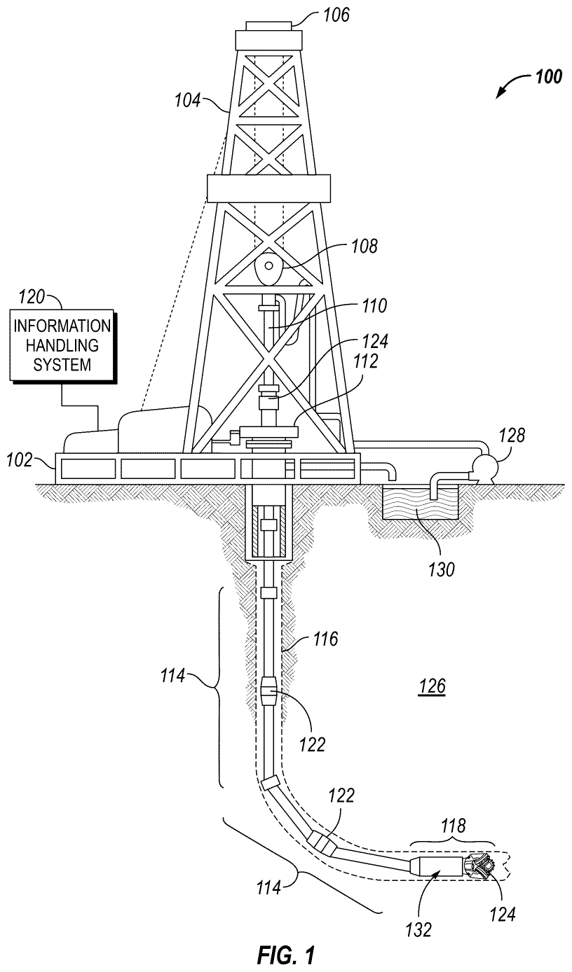

FIG. 1 is a diagram of an example drilling environment. Drilling environment 100 may comprise platform 102 that supports derrick 104 having a traveling block 108 for raising and lowering top drive 110 and drillstring 114. Top drive 110 supports and rotates drillstring 114 as it is lowered through wellhead 112. In turn, drill bit 124, located at the end of drillstring 114, may create borehole 116. Borehole 116 may be formed through the Earth surface into a subterranean formation 126 in the Earth crust. Bottom-hole assembly 118 may comprise one or more tools 132 for logging while drilling operations.

Platform 102 is a structure which may be used to support one or more other components of drilling environment 100 (e.g., derrick 104). Platform 102 may be designed and constructed from suitable materials (e.g., concrete) which are able to withstand the forces applied by other components (e.g., the weight and counterforces experienced by derrick 104). In any embodiment, platform 102 may be constructed to provide a uniform surface for drilling operations in drilling environment 100.

Derrick 104 is a structure which may support, contain, and/or otherwise facilitate the operation of one or more pieces of the drilling equipment. In any embodiment, derrick 104 may provide support for crown block 106, traveling block 108, and/or any part connected to (and including) drillstring 114. Derrick 104 may be constructed from any suitable materials (e.g., steel) to provide the strength necessary to support those components.

Crown block 106 is one or more simple machine(s) which may be rigidly affixed to derrick 104 and comprise a set of pulleys (e.g., a “block”), threaded (e.g., “reeved”) with a drilling line (e.g., a steel cable), to provide mechanical advantage. Crown block 106 may be disposed vertically above traveling block 108, where traveling block 108 is threaded with the same drilling line.

Traveling block 108 is one or more simple machine(s) which may be movably affixed to derrick 104 and comprise a set of pulleys, threaded with a drilling line, to provide mechanical advantage. Traveling block 108 may be disposed vertically below crown block 106, where crown block 106 is threaded with the same drilling line. In any embodiment, traveling block 108 may be mechanically coupled to drillstring 114 (e.g., via top drive 110) and allow for drillstring 114 (and/or any component thereof) to be lifted from (and out of) borehole 116. Both crown block 106 and traveling block 108 may use a series of parallel pulleys (e.g., in a “block and tackle” arrangement) to achieve significant mechanical advantage, allowing for the drillstring to handle greater loads (compared to a configuration that uses non-parallel tension). Traveling block 108 may move vertically (e.g., up, down) within derrick 104 via the extension and retraction of the drilling line.

Top drive 110 is a machine which may be configured to rotate drillstring 114. Top drive 110 may be affixed to traveling block 108 and configured to move vertically within derrick 104 (e.g., along with traveling block 108). In any embodiment, the rotation of drillstring 114 (caused by top drive 110) may allow for drillstring 114 to carve borehole 116. Top drive 110 may use one or more motor(s) and gearing mechanism(s) to cause rotations of drillstring 114. In any embodiment, a rotatory table (not shown) and a “Kelly” drive (not shown) may be used in addition to, or instead of, top drive 110.

Wellhead 112 is a machine which may comprise one or more pipes, caps, and/or valves to provide pressure control for contents within borehole 116 (e.g., when fluidly connected to a well (not shown)). In any embodiment, during drilling, wellhead 112 may be equipped with a blowout preventer (not shown) to prevent the flow of higher-pressure fluids (in borehole 116) from escaping to the surface in an uncontrolled manner. Wellhead 112 may be equipped with other ports and/or sensors to monitor pressures within borehole 116 and/or otherwise facilitate drilling operations.

Drillstring 114 is a machine which may be used to carve borehole 116 and/or gather data from borehole 116 and the surrounding geology. Drillstring 114 may comprise one or more drillpipe(s), one or more repeater(s) 120, and bottom-hole assembly 118. Drillstring 114 may rotate (e.g., via top drive 110) to form and deepen borehole 116 (e.g., via drill bit 124) and/or via one or more motor(s) attached to drillstring 114.

Borehole 116 is a hole in the ground which may be formed by drillstring 114 (and one or more components thereof). Borehole 116 may be partially or fully lined with casing to protect the surrounding ground from the contents of borehole 116, and conversely, to protect borehole 116 from the surrounding ground.

Bottom-hole assembly 118 may be a designated area which may comprise one or more tools 132 for creating, providing structure, and maintaining borehole 116, as well as one or more tools 132 for measuring the surrounding environment (e.g., measurement while drilling (MWD), logging while drilling (LWD)). In any embodiment, bottom-hole assembly 118 may be disposed at (or near) the end of drillstring 114 (e.g., in the most “downhole” portion of borehole 116).

Non-limiting examples of tools 132 that may be comprised in bottom-hole assembly 118 comprise a drill bit (e.g., drill bit 124), casing tools (e.g., a shifting tool), a plugging tool, a mud motor, a drill collar (thick-walled steel pipes that provide weight and rigidity to aid the drilling process), actuators (and pistons attached thereto), a steering system, and any measurement tool (e.g., sensors, probes, particle generators, etc.).

Further, bottom-hole assembly 118 may comprise a telemetry sub to maintain a communications link with the surface (e.g., with information handling system 120). Such telemetry communications may be used for (i) transferring tool measurement data from bottom-hole assembly 118 to surface receivers, and/or (ii) receiving commands (from the surface) to bottomhole assembly 118 (e.g., for use of one or more tool(s) 132 in bottom-hole assembly 118). In examples, telemetry communications may be at least in part between bottom-hole assembly 118 and information handling system 120.

As illustrated, the information handling system 120 may comprise any instrumentality or aggregate of instrumentalities operable to compute, estimate, classify, process, transmit, broadcast, receive, retrieve, originate, switch, store, display, manifest, detect, record, reproduce, handle, or utilize any form of information, intelligence, or data for business, scientific, control, or purposes. For example, an information handling system 120 may be a personal computer, a network storage device, or any other suitable device and may vary in size, shape, performance, functionality, and price.

Information handling system 120 may comprise a processing unit (e.g., microprocessor, central processing unit, etc.) that may [Tie current figure to next figure], discussed below, by executing software or instructions obtained from a local non-transitory computer readable media (e.g., optical disks, magnetic disks). The non-transitory computer readable media may store software or instructions of the methods described herein. Non-transitory computer readable media may comprise any instrumentality or aggregation of instrumentalities that may retain data and/or instructions for a period of time. Non-transitory computer readable media may comprise, for example, storage media such as a direct access storage device (e.g., a hard disk drive or floppy disk drive), a sequential access storage device (e.g., a tape disk drive), compact disk, CD-ROM, DVD, RAM, ROM, electrically erasable programmable read-only memory (EEPROM), and/or flash memory; as well as communications media such wires, optical fibers, microwaves, radio waves, and other electromagnetic and/or optical carriers; and/or any combination of the foregoing. Information handling system 120 may also comprise input device(s) (e.g., keyboard, mouse, touchpad, etc.) and output device(s) (e.g., monitor, printer, etc.). The input device(s) and output device(s) provide a user interface that enables an operator to interact with any device disposed or a part of bottom-hole assembly 118, discussed below, and/or software executed by a processing unit. For example, information handling system 120 may enable an operator to select analysis options, view collected log data, view analysis results, and/or perform other tasks.

Non-limiting examples of techniques for transferring tool measurement data (to the surface) comprise mud pulse telemetry and through-wall acoustic signaling. For through-wall acoustic signaling, one or more repeater(s) 122 may detect, amplify, and re-transmit signals from bottom-hole assembly 118 to the surface (e.g., to information handling system 120), and conversely, from the surface (e.g., from information handling system 120) to bottom-hole assembly 118.

Repeater 122 is a device which may be used to receive and send signals from one component of drilling environment 100 to another component of drilling environment 100. As a non-limiting example, repeater 122 may be used to receive a signal from a tool 132 on bottom-hole assembly 118 and send that signal to information handling system 120. Two or more repeaters 122 may be used together, in series, such that a signal to/from bottom-hole assembly 118 may be relayed through two or more repeaters 122 before reaching its destination.

A transducer is a device that may work with repeater 122 to transfer information from the surface to bottom-hole assembly 118. A transducer may be configured to convert non-digital data (e.g., vibrations, other analog data) into a digital form suitable for information handling system 120. As a non-limiting example, the one or more transducer(s) may convert signals between mechanical and electrical forms, enabling information handling system 120 to receive the signals from a telemetry sub, on bottom-hole assembly 118, and conversely, transmit a downlink signal to the telemetry sub on bottom-hole assembly 118. In any embodiment, the transducer may be located at the surface and/or any part of drillstring 114 (e.g., as part of bottom-hole assembly 118).

Drill bit 124 is a machine which may be used to cut through, scrape, and/or crush (i.e., break apart) materials in the ground (e.g., rocks, dirt, clay, etc.). Drill bit 124 may be disposed at the frontmost point of drillstring 114 and bottom-hole assembly 118. In any embodiment, drill bit 124 may comprise one or more cutting edges (e.g., hardened metal points, surfaces, blades, protrusions, etc.) to form a geometry which aids in breaking ground materials loose and further crushing that material into smaller sizes. In any embodiment, drill bit 124 may be rotated and forced into (i.e., pushed against) the ground material to cause the cutting, scraping, and crushing action. The rotations of drill bit 124 may be caused by top drive 110 and/or one or more motor(s) located on drillstring 114 (e.g., on bottom-hole assembly 118).

Pump 128 is a machine that may be used to circulate drilling fluid 130 from a reservoir, through a feed pipe, to derrick 104, to the interior of drillstring 114, out through drill bit 124 (through orifices, not shown), back upward through borehole 116 (around drillstring 114), and back into the reservoir. In any embodiment, any appropriate pump 128 may be used (e.g., centrifugal, gear, etc.) which is powered by any suitable means (e.g., electricity, combustible fuel, etc.).

Drilling fluid 130 is a liquid which may be pumped through drillstring 114 and borehole 116 to collect drill cuttings, debris, and/or other ground material from the end of borehole 116 (e.g., the volume most recently hollowed by drill bit 124). Further, drilling fluid 130 may provide conductive cooling to drill bit 124 (and/or bottom-hole assembly 118). In any embodiment, drilling fluid 130 may be circulated via pump 128 and filtered to remove unwanted debris.

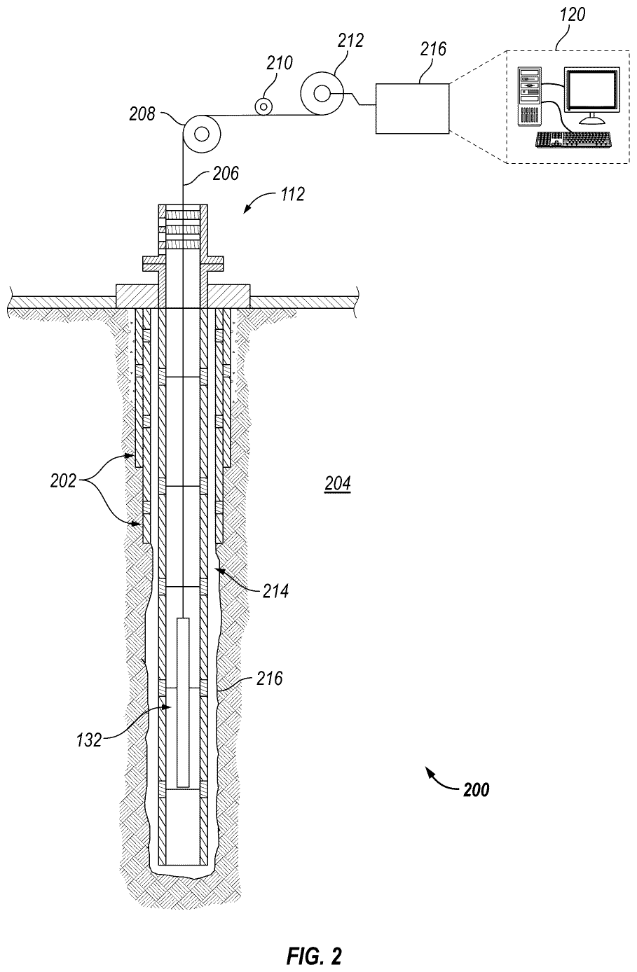

FIG. 2 illustrates a wireline operation 200, as disclosed herein, utilizing one or more tools 132. Further, FIG. 2 illustrates a cross-section of borehole 116 with one or more tools 132 traveling through casing string 202. Borehole 116 may traverse through subterranean formation 204 as a vertical well and/or a horizontal well. One or more tools 132 may be suspended by a conveyance 206, which communicates power from a logging center 208 to one or more tools 132 and communicates telemetry from one or more tools 132 to information handling system 120. In examples, one or more tools 132 may be operatively coupled to a conveyance 206 (e.g., wireline, slickline, coiled tubing, pipe, downhole tractor, and/or the like) which may provide mechanical suspension, as well as electrical connectivity, for one or more tools 132. Conveyance 206 and one or more tools 132 may extend within casing string 202 to a depth within borehole 116. Conveyance 206, which may comprise one or more electrical conductors, may exit wellhead 112, may pass around pulley 208, may engage odometer 210, and may be reeled onto winch 212, which may be employed to raise and lower the tool assembly in borehole 116. Wellhead 112 may allow for entry into borehole 116 and placement of one or more tools 132 into pipe string 214. The position of one or more tools 132 may be monitored in a number of ways, including an inertial tracker in one or more tools 132 and a paid-out conveyance length monitor in logging facility 208.

Multiple such measurements may be desirable to enable the system to compensate for varying cable tension and cable stretch due to other factors. Information handling system 120 in logging facility 208 collects telemetry and position measurements and provides position-dependent logs of measurements from one or more tools 132 and values that may be derived therefrom.

One or more tools 132 generally Comprises multiple instruments for measuring a variety of downhole parameters. Wheels, bow springs, fins, pads, or other centralizing mechanisms may be employed to keep one or more tools 132 near the borehole axis during measurement operations. During measurement operations, generally, measurements may be performed as one or more tools 132 is drawn up hole at a constant rate. The parameters and instruments may vary depending on the needs of the measurement operation.

Measurements taken by one or more tools 132 may be gathered and/or processed by information handling system 120. For example, signals recorded by one or more tools 132 may be sent to information handling system 120 where they may be stored on memory and then processed. The processing may be performed real-time during data acquisition or after recovery of one or more tools 132. Processing may alternatively occur downhole on an information handling system disposed on one or more tools 132 or may occur both downhole and at surface. In some examples, signals recorded by one or more tools 132 may be conducted to information handling system 120 by way of conveyance 206. Information handling system 120 may process the signals, and the information contained therein may be displayed for an operator to observe and stored for future processing and reference. Information handling system 120 may also contain an apparatus for supplying control signals and power to one or more tools 132.

In wireline operations 200, a digital telemetry system may be employed, wherein an electrical circuit may be used to both supply power to one or more tools 132 and to transfer data between information handling system 120 and one or more tools 132. A DC voltage may be provided to one or more tools 132 by a power supply located above ground level, and data may be coupled to the DC power conductor by a baseband current pulse system. Alternatively, one or more tools 132 may be powered by batteries located within the downhole tool assembly, and/or the data provided by one or more tools 132 may be stored within the downhole tool assembly, rather than transmitted to the surface during logging.

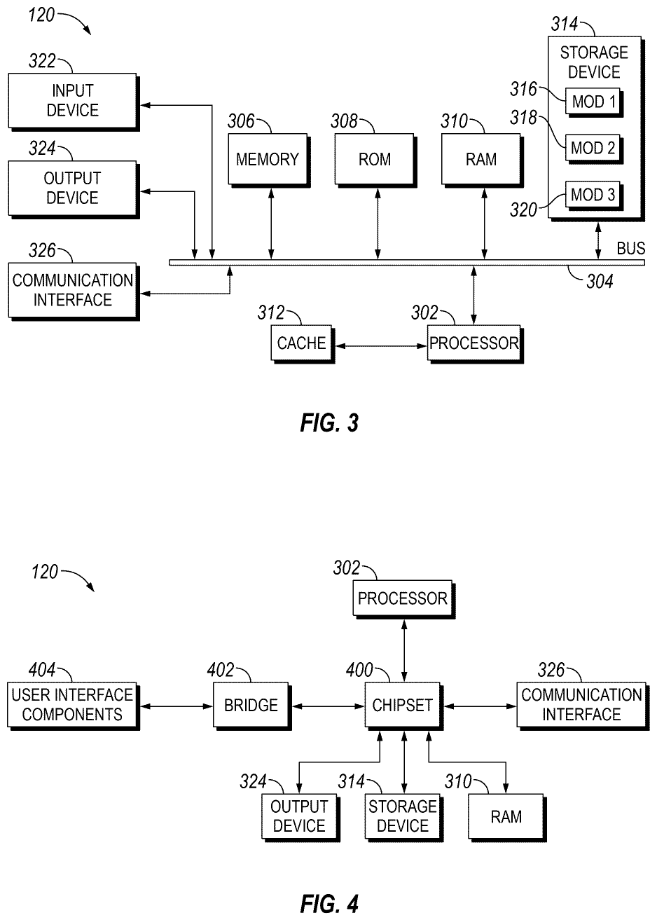

FIG. 3 further illustrates an example information handling system 120 which may be employed to perform various steps, methods, and techniques disclosed herein. Persons of ordinary skill in the art will readily appreciate that other system examples are possible. As illustrated, information handling system 120 includes a processing unit (CPU or processor) 302 and a system bus 304 that couples various system components including system memory 306 such as read only memory (ROM) 308 and random-access memory (RAM) 310 to processor 302. Processors disclosed herein may all be forms of this processor 302. Information handling system 120 may include a cache 312 of high-speed memory connected directly with, in close proximity to, or integrated as part of processor 302. Information handling system 120 copies data from memory 306 and/or storage device 314 to cache 312 for quick access by processor 302. In this way, cache 312 provides a performance boost that avoids processor 302 delays while waiting for data. These and other modules may control or be configured to control processor 302 to perform various operations or actions. Other system memory 306 may be available for use as well. Memory 306 may include multiple different types of memory with different performance characteristics. It may be appreciated that the disclosure may operate on information handling system 120 with more than one processor 302 or on a group or cluster of computing devices networked together to provide greater processing capability. Processor 302 may include any general-purpose processor and a hardware module or software module, such as first module 316, second module 318, and third module 320 stored in storage device 314, configured to control processor 302 as well as a special-purpose processor where software instructions are incorporated into processor 302. Processor 302 may be a self-contained computing system, containing multiple cores or processors, a bus, memory controller, cache, etc. A multi-core processor may be symmetric or asymmetric. Processor 302 may include multiple processors, such as a system having multiple, physically separate processors in different sockets, or a system having multiple processor cores on a single physical chip. Similarly, processor 302 may include multiple distributed processors located in multiple separate computing devices but working together such as via a communications network. Multiple processors or processor cores may share resources such as memory 306 or cache 312 or may operate using independent resources. Processor 302 may include one or more state machines, an application specific integrated circuit (ASIC), or a programmable gate array (PGA) including a field PGA (FPGA).

Each individual component discussed above may be coupled to system bus 304, which may connect each and every individual component to each other. System bus 304 may be any of several types of bus structures including a memory bus or memory controller, a peripheral bus, and a local bus using any of a variety of bus architectures. A basic input/output (BIOS) stored in ROM 308 or the like, may provide the basic routine that helps to transfer information between elements within information handling system 120, such as during start-up. Information handling system 120 further includes storage devices 314 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. Storage device 314 may include software modules 316, 318, and 320 for controlling processor 302. Information handling system 120 may include other hardware or software modules. Storage device 314 is connected to the system bus 304 by a drive interface. The drives and the associated computer-readable storage devices provide nonvolatile storage of computer-readable instructions, data structures, program modules and other data for information handling system 120. In one aspect, a hardware module that performs a particular function includes the software component stored in a tangible computer-readable storage device in connection with hardware components, such as processor 302, system bus 304, and so forth, to carry out a particular function. In another aspect, the system may use a processor and computer-readable storage device to store instructions which, when executed by the processor, cause the processor to perform operations, a method or other specific actions. The basic components and appropriate variations may be modified depending on the type of device, such as whether information handling system 120 is a small, handheld computing device, a desktop computer, or a computer server. When processor 302 executes instructions to perform “operations”, processor 302 may perform the operations directly and/or facilitate, direct, or cooperate with another device or component to perform the operations.

As illustrated, information handling system 120 employs storage device 314, which may be a hard disk or other types of computer-readable storage devices which may store data that are accessible by a computer, such as magnetic cassettes, flash memory cards, digital versatile disks (DVDs), cartridges, random access memories (RAMs) 310, read only memory (ROM) 308, a cable containing a bit stream and the like, which may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with information handling system 120, an input device 322 represents any number of input mechanisms, such as a microphone for speech, a touch-sensitive screen for gesture or graphical input, keyboard, mouse, motion input, speech and so forth. Additionally, input device 322 may receive one or more measurements from bottom-hole assembly 118 (e.g., referring to FIG. 1), discussed above. An output device 324 may also be one or more of a number of output mechanisms known to those of skill in the art. In some instances, multimodal systems enable a user to provide multiple types of input to communicate with information handling system 120. Communications interface 326 generally governs and manages the user input and system output. There is no restriction on operating on any particular hardware arrangement and therefore the basic hardware depicted may easily be substituted for improved hardware or firmware arrangements as they are developed.

As illustrated, each individual component described above is depicted and disclosed as individual functional blocks. The functions these blocks represent may be provided through the use of either shared or dedicated hardware, including, but not limited to, hardware capable of executing software and hardware, such as a processor 302, that is purpose-built to operate as an equivalent to software executing on a general purpose processor. For example, the functions of one or more processors presented in FIG. 3 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 308 for storing software performing the operations described below, and random-access memory (RAM) 310 for storing results. Very large-scale integration (VLSI) hardware embodiments, as well as custom VLSI circuitry in combination with a general-purpose DSP circuit, may also be provided.

FIG. 4 illustrates an example information handling system 120 having a chipset architecture that may be used in executing the described method and generating and displaying a graphical user interface (GUI). Information handling system 120 is an example of computer hardware, software, and firmware that may be used to implement the disclosed technology. Information handling system 120 may include a processor 302, representative of any number of physically and/or logically distinct resources capable of executing software, firmware, and hardware configured to perform identified computations. Processor 302 may communicate with a chipset 400 that may control input to and output from processor 302. In this example, chipset 400 outputs information to output device 324, such as a display, and may read and write information to storage device 314, which may include, for example, magnetic media, and solid-state media. Chipset 400 may also read data from and write data to RAM 310. A bridge 402 for interfacing with a variety of user interface components 404 may be provided for interfacing with chipset 400. Such user interface components 404 may include a keyboard, a microphone, touch detection and processing circuitry, a pointing device, such as a mouse, and so on. In general, inputs to information handling system 120 may come from any of a variety of sources, machine generated and/or human generated.

Chipset 400 may also interface with one or more communication interfaces 326 that may have different physical interfaces. Such communication interfaces 326 may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 302 analyzing data stored in storage device 314 or RAM 310. Further, information handling system 120 receives inputs from a user via user interface components 404 and executes appropriate functions, such as browsing functions by interpreting these inputs using processor 302.

In examples, information handling system 120 may also include tangible and/or non-transitory computer-readable storage devices for carrying or having computer-executable instructions or data structures stored thereon. Such tangible computer-readable storage devices may be any available device that may be accessed by a general purpose or special purpose computer, including the functional design of any special purpose processor as described above. By way of example, and not limitation, such tangible computer-readable devices may include RAM, ROM, EEPROM, CD-ROM or other optical disk storage, magnetic disk storage or other magnetic storage devices, or any other device which may be used to carry or store program code in the form of computer-executable instructions, data structures, or processor chip design. When information or instructions are provided via a network, or another communications connection (either hardwired, wireless, or combination thereof), to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code for executing steps of the methods disclosed herein. The particular sequence of such executable instructions or associated data structures represents examples of corresponding acts for implementing the functions described in such steps.

In additional examples, methods may be practiced in network computing environments with many types of computer system configurations, including personal computers, hand-held devices, multi-processor systems, microprocessor-based or programmable consumer electronics, network PCs, minicomputers, mainframe computers, and the like. Examples may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

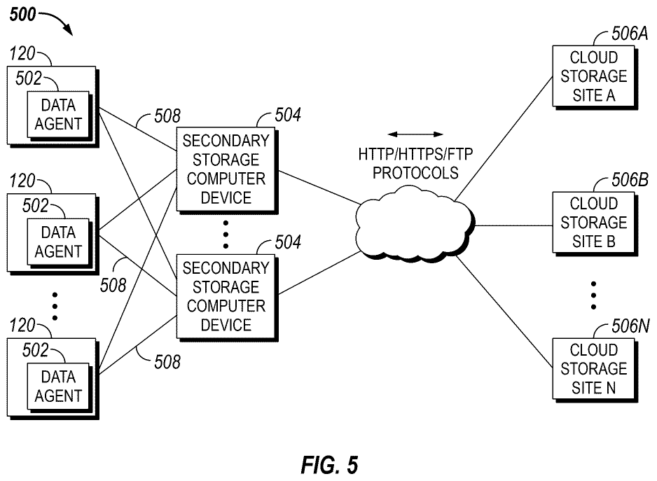

FIG. 5 illustrates an example of one arrangement of resources in a computing network 500 that may employ the processes and techniques described herein, although many others are of course possible. As noted above, an information handling system 120, as part of their function, may utilize data, which includes files, directories, metadata (e.g., access control list (ACLS) creation/edit dates associated with the data, etc.), and other data objects. The data on the information handling system 120 is typically a primary copy (e.g., a production copy). During a copy, backup, archive or other storage operation, information handling system 120 may send a copy of some data objects (or some components thereof) to a secondary storage computing device 504 by utilizing one or more data agents 502.

A data agent 502 may be a desktop application, website application, or any software-based application that is run on information handling system 120. As illustrated, information handling system 120 may be disposed at any rig site, off site location, or repair and manufacturing center. The data agent may communicate with a secondary storage computing device 504 using communication protocol 508 in a wired or wireless system. Communication protocol 508 may function and operate as an input to a website application. In the website application, field data related to pre- and post-operations, generated DTCs, notes, and the like may be uploaded. Additionally, information handling system 120 may utilize communication protocol 508 to access processed measurements, operations with similar DTCs, troubleshooting findings, historical run data, and/or the like. This information is accessed from secondary storage computing device 504 by data agent 502, which is loaded on information handling system 120.

Secondary storage computing device 504 may operate and function to create secondary copies of primary data objects (or some components thereof) in various cloud storage sites 506A-N. Additionally, secondary storage computing device 504 may run determinative algorithms on data uploaded from one or more information handling systems 120, discussed further below. Communications between the secondary storage computing devices 504 and cloud storage sites 506A-N may utilize REST protocols (Representational state transfer interfaces) that satisfy basic C/R/U/D semantics (Create/Read/Update/Delete semantics), or other hypertext transfer protocol (“HTTP”)-based or file-transfer protocol (“FTP”)-based protocols (e.g., Simple Object Access Protocol).

In conjunction with creating secondary copies in cloud storage sites 506A-N, the secondary storage computing device 504 may also perform local content indexing and/or local object-level, sub-object-level or block-level deduplication when performing storage operations involving various cloud storage sites 506A-N. Cloud storage sites 506A-N may further record and maintain data and/or provide outputs from determinative algorithms that are located in cloud storage sites 506A-N. In a non-limiting example, this type of network may be utilized as a platform to store, backup, analyze, import, perform extract, transform and load (“ETL”) processes, mathematically process, apply machine learning models, and augment measurement data.

A machine learning model may be an empirically derived model which may result from a machine learning algorithm identifying one or more underlying relationships within a dataset. In comparison to a physics-based model, such as Maxwell's Equations, which are derived from first principals and define the mathematical relationship of a system, a pure machine learning model may not be derived from first principles. Once a machine learning model is developed, it may be queried in order to predict one or more outcomes for a given set of inputs. The type of input data used to query the model to create the prediction may correlate both in category and type to the dataset from which the model was developed.

The structure of, and the data contained within a dataset provided to a machine learning algorithm may vary depending on the intended function of the resulting machine learning model. The rows of data, or data points, within a dataset may contain one or more independent values. Additionally, datasets may contain corresponding dependent values. The independent values of a dataset may be referred to as “features,” and a collection of features may be referred to as a “feature space.” If dependent values are available in a dataset, they may be referred to as outcomes or “a target value.” Although dependent values may be a component of a dataset for certain algorithms, not all algorithms require a dataset with dependent values. Furthermore, both the independent and dependent values of the dataset may comprise either numerical or categorical values.

While it may be true that machine learning model development is more successful with a larger dataset, it may also be the case that the whole dataset isn't used to train the model. A test dataset may be a portion of the original dataset which is not presented to the algorithm for model training purposes. Instead, the test dataset may be used for what may be known as “model validation,” which may be a mathematical evaluation of how successfully a machine learning algorithm has learned and incorporated the underlying relationships within the original dataset into a machine learning model. This may include evaluating model performance according to whether the model is over-fit or under-fit. As it may be assumed that all datasets contain some level of error, it may be important to evaluate and optimize the model performance and associated model fit by a model validation. In general, the variability in model fit (e.g., whether a model is over-fit or under-fit) may be described by the “bias-variance trade-off.” As an example, a model with high bias may be an under-fit model, where the developed model is over-simplified, and has either not fully learned the relationships within the dataset or has over-generalized the underlying relationships. A model with high variance may be an over-fit model which has overlearned about non-generalizable relationships within training dataset which may not be present in the test dataset. In a non-limiting example, these non-generalizable relationships may be driven by factors such as intrinsic error, data heterogeneity, and the presence of outliers within the dataset. The selected ratio of training data to test data may vary based on multiple factors, including, in a non-limiting example, the homogeneity of the dataset, the size of the dataset, the type of algorithm used, and the objective of the model. The ratio of training data to test data may also be determined by the validation method used, wherein some non-limiting examples of validation methods include k-fold cross-validation, stratified k-fold cross-validation, bootstrapping, leave-one-out cross-validation, resubstitution, random subsampling, and percentage hold-out.

In addition to the parameters that exist within the dataset, such as the independent and dependent variables, machine learning algorithms may also utilize parameters referred to as “hyperparameters.” Each algorithm may have an intrinsic set of hyperparameters which guide what and how an algorithm learns about the training dataset by providing limitations or operational boundaries to the underlying mathematical workflows on which the algorithm functions. Furthermore, hyperparameters may be classified as either model hyperparameters or algorithm parameters.

Model hyperparameters may guide the level of nuance with which an algorithm learns about a training dataset, and as such model hyperparameters may also impact the performance or accuracy of the model that is ultimately generated. Modifying or tuning the model hyperparameters of an algorithm may result in the generation of substantially different models for a given training dataset. In some cases, the model hyperparameters selected for the algorithm may result in the development of an over-fit or under-fit model. As such, the level to which an algorithm may learn the underlying relationships within a dataset, including the intrinsic error, may be controlled to an extent by tuning the model hyperparameters.

Model hyperparameter selection may be optimized by identifying a set of hyperparameters which minimize a predefined loss function. An example of a loss function for a supervised regression algorithm may include the model error, wherein the optimal set of hyperparameters correlates to a model which produces the lowest difference between the predictions developed by the produced model and the dependent values in the dataset. In addition to model hyperparameters, algorithm hyperparameters may also control the learning process of an algorithm, however algorithm hyperparameters may not influence the model performance. Algorithm hyperparameters may be used to control the speed and quality of the machine learning process. As such, algorithm hyperparameters may affect the computational intensity associated with developing a model from a specific dataset.

Machine learning algorithms, which may be capable of capturing the underlying relationships within a dataset, may be broken into different categories. One such category may include whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset includes both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may include Neural Networks, K-Nearest Neighbors, Naïve Bayes, Decision Trees, Classification Trees, Regression Trees, Random Forests, Linear Regression, Support Vector Machines (SVM), Gradient Boosting Regression, and Perception Back-Propagation.

The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not include a dependent variable as the intended function of this type of algorithm is to identify one or more groupings or clusters within a dataset. In a non-limiting example, algorithms which may be utilized for unsupervised machine learning may include K-means clustering, K-means classification, Fuzzy C-Means, Gaussian Mixture, Hidden Markov Model, Neural Networks, and Hierarchical algorithms.

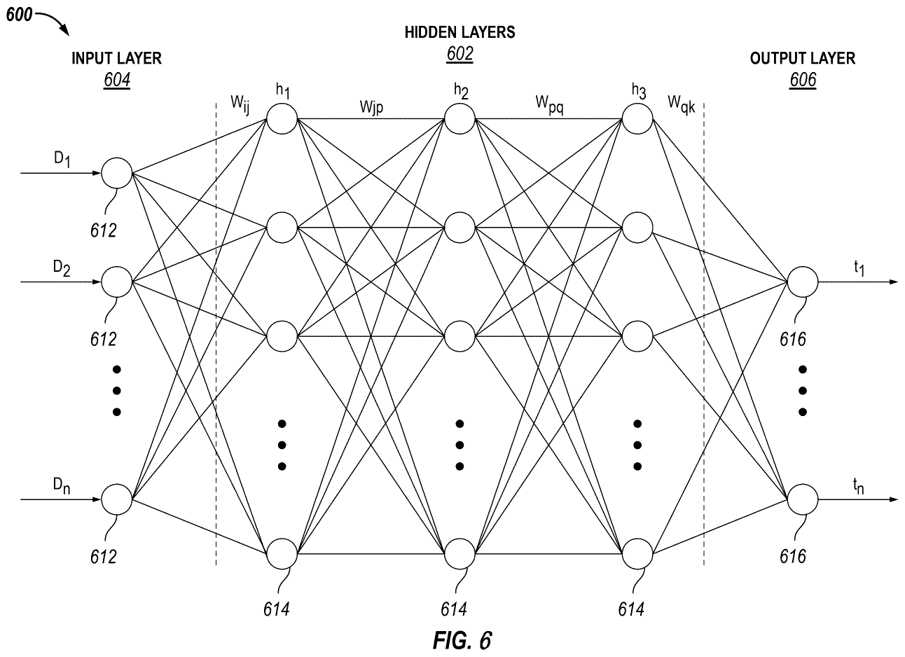

FIG. 6 illustrates neural network (NN) 600. NN 600 may operate utilizing one or more information handling systems 120 (e.g., referring to FIG. 1) on computing network 600. Although a NN is illustrated, multiple models may be used with input output structures. These models may include flexible empirical models such as NN, gaussian processing methods, kriging methods, evolutionary methods such as genetic algorithms, classification methods, clustering methods empirical methods, or physics based methods such as equations of state, thermodynamic models, geological, geochemistry, or chemistry models, or kinetic models or any combinations therein including recursive combinations of similar or dissimilar models and iterative model combinations. A NN 600 is an artificial neural network with one or more hidden layers 602 between input layer 604 and output layer 606. In examples, NN 600 may be software on a single information handling system 120. In other examples, NN 600 may software running on multiple information handling systems 120 connected wirelessly and/or by a hard-wired connection in a network of multiple information handling systems 120. Herein, NN 600 may be applied in a wide array of implementations.

During operations, inputs 608 data are given to neurons 612 in input layer 604. Neurons 612, 614, and 616 are defined as individual or multiple information handling systems 120 connected in a computing network 500. The output from neurons 612 may be transferred to one or more neurons 614 within one or more hidden layers 602. Hidden layers 602 includes one or more neurons 614 connected in a network that further process information from neurons 612. The number of hidden layers 602 and neurons 612 in hidden layer 602 may be determined by personnel that design NN 600. Hidden layers 602 is defined as a set of information handling systems 120 assigned to specific processing. Hidden layers 602 spread computation to multiple neurons 612, which may allow for faster computing, processing, training, and learning by NN 600. Output from NN 600 may be computed by neurons 616. Information handling system 120 and the systems that may comprise one or more information handling systems 120 (e.g., referring to FIG. 1) may be utilized in creating a physics-based model.

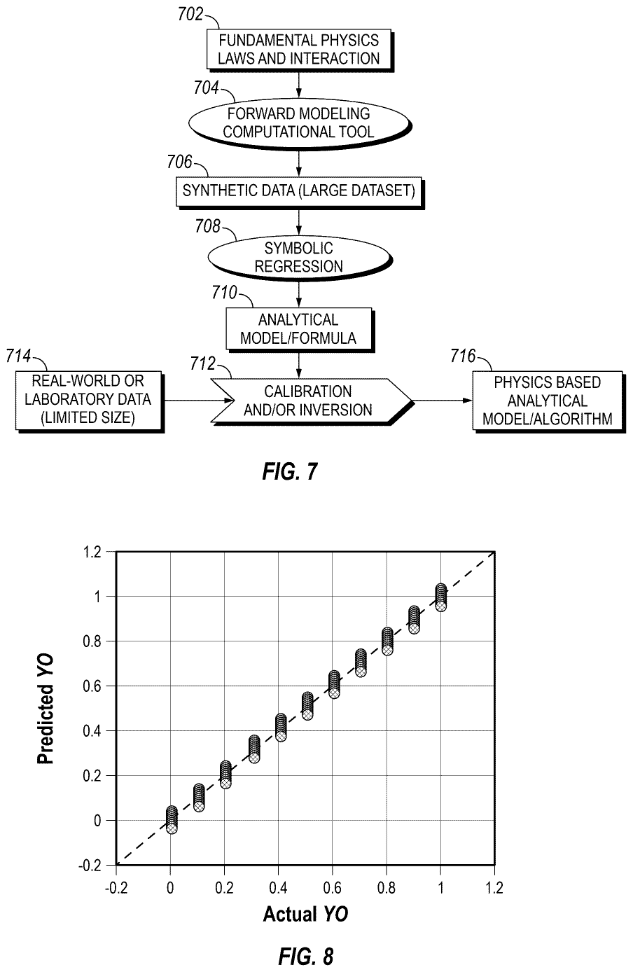

FIG. 7 illustrates workflow 700 for creating a physics-based model. It should be noted that workflow 700 may be performed, at least in part, on one or more information handling systems 120. Workflow 700 may begin with block 702. In block 702, fundamental physical laws and/or interaction mechanisms may be incorporated into a computational model. While any fundamental physical laws may be utilized, in examples, fundamental nuclear physics equations may be used. For example, Equation (1) below may be populated onto the computational model:

$$ϕ {S}_{0} = 1.19 * \frac{\frac{{Y}_{c}}{{Y}_{0}} ( 1 - . 35 ϕ ) - . 32 {V}_{l s} ( 1 - ϕ )}{( {ρ}_{h} + . 78 \frac{{Y}_{0}}{{Y}_{0}} )} \qquad ( 1 )$$

Herein Yc/Yo is the carbon oxygen ratio and S₀ is oil saturation, φ is formation porosity, n porosity Vᵢₛ is liquid superficial velocity and ρₕ is holdup density or homogeneous density. In addition, any number of relevant physics based equations may be utilized into the computational model. Herein, fundamental physics laws and/or interaction mechanisms may be defined as any equation, law, function, theory, or any other physics-based quantitative construct between parameters which explains measurements, downhole properties, orientation of a tool, or any other information downhole. Whether or not the equations are relevant is determined by the properties being measured in the formation and if they have any parameter which has any possible relationship with a measurement.

In block 704, a forward modeling computation tool may be designed from inputs from block 702 and a test setup. In examples, the forward modeling computational tool may be the physical system to be tested (e.g., tool geometry, materials under test, etc.), and provides a response from fundamental nuclear physics equation(s) from block 702. A test setup matching the computational model is constructed representing real-world data. In examples, the forward modeling computation tool may mock laboratory or downhole measurements. As such, real-world data may be mocked, or methods and systems described herein may yield mocked real-world data. Any sensor parameters such as geometry and material, as well as test media and environment, may affect the computational model. In examples, matching herein may be laboratory constructed system must be as consistent as possible to the real-world scenario. As such, in block 704 a comparison is made between test set up with operations mocking downhole measurements and laboratory results to the inputs from block 702. With the comparison, laboratory and downhole measurements results may be shaped to more closely match the equations from block 702.

The data contains C/O signal ratio CO_{n_synthetic} and/or CO_{n_lab}, oil holdup Y₀, formation oil saturation S₀, formation porosity φ, tool position in the borehole cen, and borehole size BS. Once the test set up is confirmed with laboratory measurements representing real-world data, measurements acquired downhole may be utilized. Confirmation of the test set up may comprise a confirmation threshold which eventually validates and ends forward modeling computational tool. In examples, confirmation thresholds may consist adapting lab measurement conditions approximates downhole measurement conditions, and downhole measurement and lab measurement parameters. In addition, due to the difference between the lab nuclear sensor instrument and downhole instrument, necessary correction is inevitably applied to rectify any systematic bias or any other bias, to a certain threshold proportional to the confirmation threshold. As discussed above, fundamental nuclear physics equations may be utilized as an example, thus, a nuclear well-logging (pulsed neutron) dataset may be used. The nuclear well-logging dataset comes from a nuclear logging tool, which is identified as one or more tools 132 (e.g., referring to FIGS. 1 and 2).

In block 706, using the computational model described above, a synthetic dataset that spans the full scope of the physical phenomena and encompasses all variable ranges may be produced. The dataset includes synthetic results coming from Monte Carlo N-Particle simulations and laboratory. The simulations and experiments are performed using the following mesh grid of parameter combinations: oil holdup Y₀=[0, 0.1, 0.2, 0.3, 0.4, 0.5, 0.6, 0.7, 0.8, 0.9, 1], formation oil saturation S₀=[0, 1] for the laboratory data, [0, 0.5, 1] for the synthetic data, formation porosity φ=[0, 0.4] for the laboratory data, [0, 0.1, 0.2, 0.3, 0.4] for the synthetic data, tool position in the borehole cen=[0, 1] for the laboratory data, [0, 0.5, 1] for the synthetic data, and borehole size BS=[6, 8] for the laboratory data, [6, 8, 10, 12] for the synthetic data.

Using laboratory data and synthetic data, it may be seen that physically meaningful and interpretable models may be obtained via symbolic regression from the synthetic data and this model may be used for real-world applications. Every possible combination of every possible mesh grid response may be applied to the designed and/or confirmed forward modeling computational model yielding synthetic data set. As such, the mesh grid of parameters comprises multiple possible number of values for every parameter from the computational model. The grids described in (1) provide a target value for every value in the grid, or a grid of target values. (2)-(5) are the data points as input parameters. Each of the input parameters can be inserted into the equation one at a time to generate a different oil holdup Y₀. For instance, if one fix borehole size BS=8 and vary other parameters, it will give the outcome represent borehole size of 6. In examples, the loaded matrices may be adjusted, and they may be altered to fit any computational model. The example illustrated above is for a specific input from block 702 loaded into the computational model. However, with any computational model with parameters, any number of mesh grids may be possible for all parameters. In examples, at least one parameter has one or more possible inputs.

In block 708, a symbolic regression may be applied for the target oil holdup Y₀ to the synthetic datasets to extract a physics-based model that is interpretable and grounded in physical principles. In examples, oil holdup Y₀ is annulus oil hold up. It represents the fraction of volume of oil in annulus. In further examples, symbolic regression is not limited to oil holdup, it may also be applied to any other parameters. Any and multiple symbolic regression algorithm may be used to extract a physics-based model from synthetic data. The physics-based equation obtained via the regressor may be Equation (2)

$${Y}_{0} = 0.5689 + 0 \text{.6436} \cdot ϕ \cdot {S}_{o} + \frac{17.34 - 10.47 \cdot ϕ \cdot {S}_{o}}{B S - 0.2080 - 0.02943 \cdot {cen}^{2} \cdot {BS}^{2}} + \frac{5.221 \cdot ϕ - 32.44}{BS \cdot {CO}_{{n}_{s y n t h e t i c}} - 0.5968 - 0.02967 \cdot {cen}^{2} \cdot {BS}^{2} \cdot {CO}_{{n}_{s y n t h e t i c}}} - 0.1754 \cdot {CO}_{{n}_{s y n t h e t i c}} + 0.01774 {CO}_{{n}_{s y n t h e t i c}}^{2} \qquad ( 2 )$$

The graph in FIG. 8 illustrates the performance of Equation (2) in estimating oil holdup Y₀. The root mean square error (RMSE) is 0.0155. Actual oil holdup Y₀ may be from synthetic data and Predicted oil holdup Y₀ may be the product computed in Equation (2). This equation adheres to the inherent physics of the problem and produces smooth results. Moreover, it is interpretable and generalizable. The physics-based model is an equation or set of equations which depicts the relationship between oil holdup Y₀ as a target and oil saturation S₀, formation porosity φ, tool position in the borehole cen, borehole size BS, and C/O signal ratio COₙ_{_{synthetic}} as inputs. This is an illustrative example, the symbolic regression may determine relationships between one or more inputs or parameters to solve for one or more targets. Symbolic regression algorithms search and apply form and accuracy between not only linear, any order of degree of non-linear equations, any degree polynomial, or a trigonometric relationship and any other possible equations. In addition, more than one product may be yielded from the symbolic regression, resulting in multiple physics-based models to solve for the target. The output of block 708 is a derived physics-based model, as discussed above.

In block 710, the physics-based model from block 708 may be tuned by analytics. For example, the physics-based model may comprise semi-analytical expressions with constants and coefficients that may be fine-tuned using actual empirical, laboratory data, or measurements from downhole sensors. From symbolic regression, a general equation for oil holdup Y₀ using synthetic data may be obtained.

In block 712 a calibration and/or inversion may be performed with actual measurements or laboratory data on the physics-based model. Real-world data from block 714 may be utilized to calibrate or tweak the physics-based model. The real-world or laboratory data may be used with physics-based model to tune the coefficients of the physics-based model. This process may be considered an inversion process. In other examples, using the analytical equations obtained from symbolic regression with synthetic models can check whether the synthetic data predicted results and real measurements are consistent. Such potential inconsistencies often may be rectified by linear or nonlinear regression and, consequently, tweaking the analytical equations to improve the model prediction performance. There may be multiple analytic equations generated by running different symbolic regression algorithms and/or by setting different termination conditions in any of these symbolic regression algorithm runs. Block 712 may compare the real-world measurements from 714 with the prediction from physics-based model from block 710 or 708 to help determine which analytic equations represents the real-measurements more satisfactorily. Furthermore, the coefficients may be tweaked by calibrating or regression of real measurements and the analytical equation obtained from symbolic regression. As such, the physics-based model may be a calibrated and tweaked analytical equation.

If the equation from block 712 captures the intrinsic physics of the problem, then the symbolic regression generated physics-based model may work for real-world (laboratory or field) data from block 714, it may then be selected and not require over tweaking or calibrating.

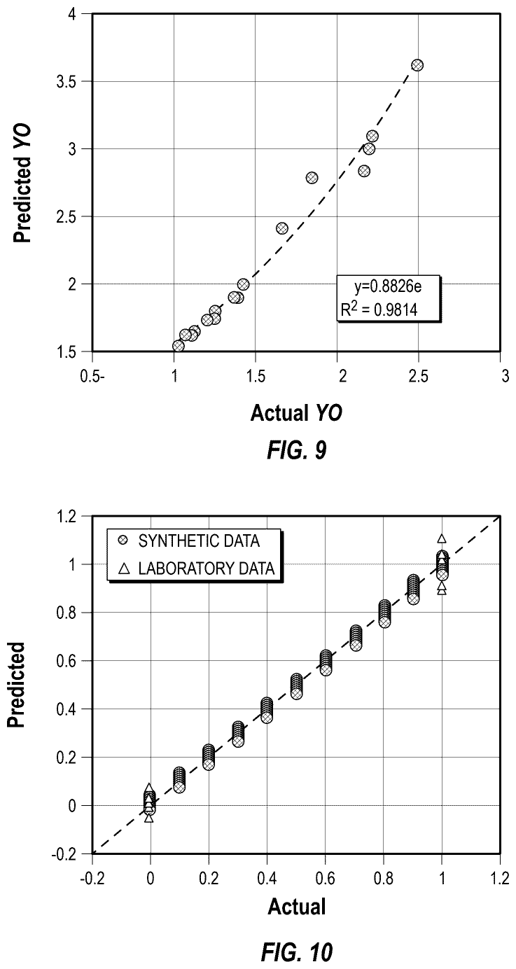

Further, synthetic and real-world data should have the same range. The graph in FIG. 9 illustrates the laboratory data/real world data against the synthetic data. The geometrical parameters in the experimental measurements may be spaced more sparsely compared to the simulations. For instance, the oil holdup Y₀ varies between 0 (all water) and 1 (all oil) in the synthetic data. However, the laboratory conditions may be more restrictive, and only the extreme values 0 and 1 of oil holdup Y₀ are available in the experimental data. The correlations observed for extremes in the graph of FIG. 9 may remain valid for intermediate conditions.

The trendline in the graph of FIG. 9 may be given as Equation (3)

$${CO}_{{n}_{s y n t h e t i c}} = 0 \text{.8826} \cdot {e}^{0.5698 C {O}_{{n}_{l a b}}} \qquad ( 3 )$$

In examples, Equation (3) may be directly inserted into Equation (2) to get the final il holdup Y₀ equation. The graph in FIG. 10 illustrates the performance of SR in estimating oil holdup Y₀ for synthetic and laboratory data. Given the assumption that the trendline in FIG. 8 holds and that laboratory data correlates with field data, Equation (2) may also be used for field data with confidence.

The results demonstrate that the equation derived for il holdup Y₀ through symbolic regression using synthetic data is applicable to experimental data. This indicates that Equation (2) effectively captures the interactions between the input parameters and measurement (COₙ). Therefore, Equation (2) has a significant potential to be a consistent model representing the physics of the problem. The constants in the SR equation may either directly correspond to physical conditions (e.g., geometrical configuration) or, when considered collectively, represent those conditions. In block 714, laboratory data, or measurements from downhole sensors, as discussed above.

In block 716, workflow 700 may yield an explainable, physics-based model that may have been tuned, calibrated, and/or inverted, but necessarily in block 710 and 712. The physics-based model can be applied to determine oil holdup Y, with downhole measurements.

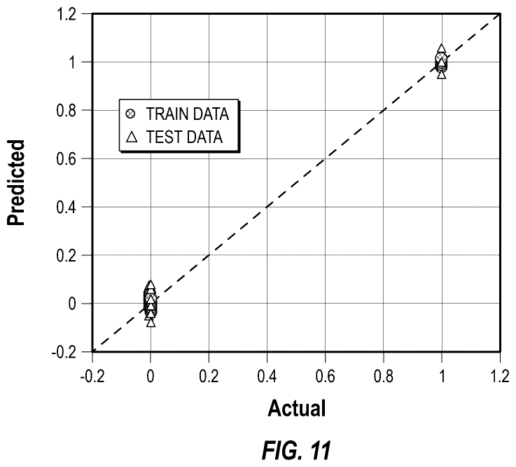

Referring back to block 712, in other examples, the constants in Equation (1) may be inverted by directly using laboratory/field data from block 714. The data may be split into training (for model parameter estimation) and testing (to check the equation performance). In operations, a leave-one-out cross-validation may be used to obtain the constants for laboratory data. Then, if the equation captures the underlying physics, must work for the test data. Equation (2) may be rewritten as Equation (4):

$${Y}_{0} = {C}_{1} + {C}_{2} \cdot ϕ \cdot {S}_{o} + \frac{{C}_{3} + {C}_{4} \cdot ϕ \cdot {S}_{o}}{{C}_{5} \cdot BS + {C}_{6} + {C}_{7} \cdot {cen}^{2} \cdot {BS}^{2}} + \frac{{C}_{8} \cdot ϕ + {C}_{9}}{{C}_{10} \cdot BS \cdot {CO}_{{n}_{s y n t h e t i c}} + {C}_{11} + {C}_{12} \cdot {cen}^{2} \cdot {BS}^{2} \cdot {CO}_{{n}_{s y n t h e t i c}}^{2}} + {C}_{13} \cdot {CO}_{{n}_{s y n t h e t i c}} + {C}_{14} \cdot {CO}_{{n}_{s y n t h e tic}}^{2} , \qquad ( 4 )$$

where C₁-C₁₄ are model constants. Given that there are fourteen constants, fifteen data points are enough to obtain the model parameters. The graph in FIG. 11 illustrates the performance in oil holdup Y₀ estimation for all possible combinations of cross-validation (18 trials for 18 data points, 18×18=324 estimations). The RMSE in oil holdup Y₀ estimation for all cross-validation combinations for train and test data are 0.0131 and 0.0436, respectively. Results indicate that a physical model may be estimated from applying symbolic regression to numerical data, and later, the model constants may be calibrated to real-world data. The constants may be optimized via non-linear inversion without regularization. Table 1 lists the statistical summary of the optimized constants. The model constants, faithfully, have physical meanings. Nonetheless, the presented approaches (correlation or constant optimization) may be used to obtain equations that work in real-world problems.

TABLE 1

| Constant | Min | Q1 | Median | Q3 | Max |
|---|---|---|---|---|---|
| C₁ | 13.74121 | 18.66286 | 19.10859 | 19.72948 | 34.56472 |
| C₂ | −1.23613 | −0.34304 | −0.19642 | −0.13003 | 0.159758 |
| C₃ | 46.9163 | 50.01425 | 51.55307 | 52.4263 | 62.04556 |
| C₄ | −4.11532 | −2.87241 | −2.65344 | −2.26556 | −0.59159 |
| C₅ | 0.116954 | 0.167036 | 0.1741 | 0.182314 | 0.252563 |
| C₆ | 0.637887 | 0.836766 | 0.880126 | 0.910934 | 1.105913 |
| C₇ | −0.00805 | −0.00542 | −0.00508 | −0.0048 | −0.00334 |
| C₈ | 1.880756 | 2.224696 | 2.283316 | 2.376887 | 2.732758 |
| C₉ | −109.337 | −88.9061 | −86.6877 | −85.2302 | −78.4036 |
| C₁₀ | 0.138247 | 0.204252 | 0.207473 | 0.216126 | 0.276871 |
| C₁₁ | 1.098825 | 1.41346 | 1.449505 | 1.470706 | 1.738382 |
| C₁₂ | −0.0088 | −0.00625 | −0.00602 | −0.00595 | −0.00395 |
| C₁₃ | −29.6282 | −17.2943 | −16.7768 | −16.3383 | −11.7275 |
| C₁₄ | 1.948865 | 2.683014 | 2.756597 | 2.840526 | 4.777845 |

Similar to Equation (2), an equation for oil holdup Y₀ may be derived from the far sensor C/O signal ratio (i.e., oil holdup Y₀ as a function of CO_{far}, formation oil saturation S₀, formation porosity φ, tool position in the borehole cen, and borehole size BS). By using two separate equations for near and far pulsed neutron sensors, it is possible to simultaneously invert for oil holdup Y₀ and oil saturation S₀, if tool position in the borehole cen and borehole size BS are already known or determined. As such, specific downhole operations to acquire tool position in the borehole cen and borehole size BS may be utilized.

Improvements systems and methods disclosed herein is that they may provide a fusion of synthetic data generation with symbolic regression to create physics-based models that are both interpretable and grounded in the underlying science, a stark contrast to the opacity of black-box machine learning methods. By systematically exploring the parameter space and capturing the full complexity of the physical interactions through synthetic datasets, this method circumvents the limitations of empirical data scarcity and noise. Symbolic regression then serves as a powerful tool to reveal the intrinsic mathematical relationships, yielding semi-analytical formulas that not only elucidate the governing physics but also allow for straightforward calibration against real-world observations. This innovative strategy stands out by providing a clear window into the mechanics of complex systems, enabling a deeper understanding and more accurate predictions than traditional data-driven approaches.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design herein shown, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method comprising:
loading one or more fundamental physics laws and/or interaction mechanisms into a computational model;
producing synthetic data for a target value with the computational model;
creating a symbolic regression for the target using the synthetic data; and
creating a physics-based model from at least the symbolic regression.

2. The method of claim 1, further comprising creating a forward modeling computational tool from the fundamental physics laws and interaction.

3. The method of claim 2, further comprising constructing a test setup comprising mocked real-world data.

4. The method of claim 3, wherein the mocked real-world data is laboratory or downhole measurements.

5. The method of claim 3, further comprising comparing the test set up to the computational model.

6. The method of claim 5, further comprising shaping laboratory or downhole measurements to remove systematic bias or any other bias.

7. The method of claim 1, wherein producing synthetic data for the target value further comprises using a mesh grid of parameters from the computational model.

8. The method of claim 7, wherein producing synthetic data for the target value further comprises using a grid of target values.

9. The method of claim 7, wherein the mesh grid of parameters comprises multiple possible number of values for every parameter from the computational model.

10. The method of claim 1, wherein the symbolic regression is linear, any degree polynomial, or a trigonometric relationship.

11. The method of claim 1, further comprising tuning the physics-based model with actual empirical, laboratory data, or measurements from downhole sensors.

12. The method of claim 1, further comprising calibrating the physics-based model with actual measurements or laboratory data.

13. A system comprising:
a tool disposed in a borehole; and
an information handling system configured to:
load one or more fundamental physics laws and/or interaction mechanisms into a computational model;
produce synthetic data for a target value with the computational model;
create a symbolic regression for the target using the synthetic data; and
creating a physics-based model from at least the symbolic regression.

14. The system of claim 13, wherein the information handling system is further configured for creating a forward modeling computational tool from the fundamental physics laws and interaction.

15. The system of claim 14, wherein the information handling system is further configured for constructing a test setup comprising mocked real-world data.

16. The system of claim 15, wherein the mocked real-world data is laboratory or downhole measurements.

17. The system of claim 16, wherein the information handling system is further configured for comparing the test set up to the computational model.

18. The system of claim 17, wherein the information handling system is further configured for shaping laboratory or downhole measurements to remove systematic bias or any other bias.

19. The system of claim 13, wherein producing synthetic data for the target value further comprises using a mesh grid of parameters from the computational model.

20. The system of claim 19, wherein producing synthetic data for the target value further comprises using a grid of target values and the mesh grid of parameters comprises multiple possible number of values for every parameter from the computational model.
